(19) United States
(12) Patent Application Publication
(10) Pub. No.: US 2007/0153192 A1
(43) Pub. Date: Jul. 5, 2007

(54) Liquid crystal display panel

(76) Inventors: Shu-I Huang, Taipei City (TW); Wei-Chieh Sun, Yonghe City (TW); Chih-Yu Peng, Hsinchu City (TW)

Correspondence Address: RABIN & Berdo, PC, 1101 14TH STREET, NW, SUITE 500, WASHINGTON, DC, 20005, US

(21) Appl. No.: 11/392,536

(22) Filed: Mar. 30, 2006

(30) Foreign Application Priority Data
Dec. 30, 2005 (TW) 94147696

(51) Int. Cl. G02F 1/1343

(52) U.S. Cl. 349/139

(57) ABSTRACT

A liquid crystal display panel including a first conductive substrate, a second conductive substrate and a liquid crystal layer is provided. The first conductive substrate includes a base, a first protrusion, a second protrusion and a photo-spacer. The first protrusion and the second protrusion disposed above the base are symmetric with respect to a central line. The second protrusion is a mirror reflection structure of the first protrusion with respect to the central line. The photo-spacer substantially disposed on the central line and positioned above the base is positioned between the first protrusion and the second protrusion. The second conductive substrate is parallel to the first conductive substrate. The liquid crystal layer is disposed between the first conductive substrate and the second conductive substrate.

This application claims the benefit of Taiwan application Serial No. 94147696, filed Dec. 30, 2005, the subject matter of which is incorporated herein by reference.

### BACKGROUND OF THE INVENTION

1. Field of the Invention

The invention relates in general to a liquid crystal display (LCD) panel, and more particularly to an LCD panel capable of preventing the photo-spacer from partly overlapping with the protrusion.

2. Description of the Related Art

The multi-domain vertical alignment (MVA) liquid crystal display (LCD) panel is widely used in recent years due to the features of faster signal response speed, wider view angle, higher transmittance, higher contrast, and better frame quality.

Referring to FIGS. 1A˜1B. FIG. 1A is a partial top view of a conventional LCD panel. FIG. 1B is a partial cross-sectional view of the LCD panel viewed along a cross-sectional line 1B-1B′ of FIG. 1A. As shown in FIGS. 1A˜1B, the LCD panel 10 includes a thin film transistor (TFT) substrate 11, a color filter (CF) substrate 12 and a liquid crystal layer 13. The thin film transistor substrate 11 is parallel to the color filter substrate 12. The liquid crystal layer 13 disposed between the thin film transistor substrate 11 and the color filter substrate 12 has a number of liquid crystal molecules 13a. Besides, the thin film transistor substrate 11 includes two scan lines S3˜S4 and three data lines D4˜D6. The scan lines S3˜S4 are mutually parallel to each other. The data lines D4˜D6, which are mutually parallel to each other, are perpendicular to and alternate with the scan lines S3˜S4 to define two pixels P3˜P4. The pixel P3 includes a thin film transistor T3 and a pixel electrode 18. The thin film transistor T3 is electrically coupled to the scan line S3, the data line D4 and the pixel electrode 18. The pixel P4 includes a thin film transistor T4 and a pixel electrode 19. The thin film transistor T4 is electrically coupled to the scan line S3, the data line D5 and the pixel electrode 19. The color filter substrate 12 includes a common electrode 14, two protrusions 15-16 and a photo-spacer 17. The protrusions 15˜16 and the photo-spacer 17 are disposed on the common electrode 14 and do not overlap under ideal conditions. The protrusions 15˜16 are used for adjusting the liquid crystal molecules 13a into a number of domains. The photo-spacer 17 is used for providing a fixed cell gap between the thin film transistor substrate 11 and color filter substrate 12.

However, when error occurs to the precision of the manufacturing process of the protrusions 15˜16 and the photo-spacer 17, the photo-spacer 17 would easily overlap with the protrusion 16, affecting the arrangement of the liquid crystal molecules 13a in the overlapped region between the photo-spacer 17 and the protrusion 16. In a worse case, the arrangement of the liquid crystal molecules 13a in the display region may even be squeezed and affected by the liquid crystal molecules 13a outside the display region. That is, when the liquid crystal molecules 13a in the overlapped region of the protrusion 16 are squeezed, the arrangement of the liquid crystal molecules 13a in the pixel electrode 18 will be affected. Therefore, during the operation of the LCD panel 10, particularly when the LCD panel 10 switches frames, image retention will occur to the partly overlapped region between the photo-spacer 17 and the protrusion 16. Thus, the display quality and practicality of the LCD panel 10 are largely deteriorated.

### SUMMARY OF THE INVENTION

It is therefore an object of the invention to provide a liquid crystal display (LCD) panel. The design of disposing two mutually mirrored and reflected protrusions to be symmetric with respect to a central line and disposing the photo-spacer on a symmetric central line positioned between the two protrusions prevents the photo-spacer from partly overlapping with the two protrusions, and avoids the occurrence of image retention during the operation of the LCD panel. Thus, the display quality and practicality of the LCD panel are largely improved.

The invention achieves the above-identified object by providing an LCD panel. The LCD panel includes a first conductive substrate, a second conductive substrate and a liquid crystal layer is provided. The first conductive substrate includes a base, a first protrusion, a second protrusion and a photo-spacer. The first protrusion and the second protrusion disposed above the base are symmetric with respect to a central line. The second protrusion is a mirror reflection structure of the first protrusion with respect to the central line. The photo-spacer substantially disposed on the central line and positioned above the base is positioned between the first protrusion and the second protrusion. The second conductive substrate is parallel to the first conductive substrate. The liquid crystal layer is disposed between the first conductive substrate and the second conductive substrate.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1A is a partial top view of a conventional LCD panel;

FIG. 1B is a partial cross-sectional view of the LCD panel viewed along a cross-sectional line 1B-1B′ of FIG. 1A;

FIG. 2A is a partial top view of a first conductive substrate of an LCD panel according to a first embodiment of the invention;

FIG. 2B is a partial cross-sectional view of the LCD panel viewed along the cross-sectional line 2B-2B′ of FIG. 2A;

FIG. 3A is a partial top view of an LCD panel according to a second embodiment of the invention;

FIG. 3B is a partial cross-sectional view of the LCD panel viewed along a cross-sectional line 3B-3B′ of FIG. 3A;

FIG. 4A is a partial top view of an LCD panel according to a third embodiment of the invention;

FIG. 4B is a partial cross-sectional view of the LCD panel viewed along a cross-sectional line 4B-4B′ of FIG. 4A;

FIG. 5 is a partial top view of a first conductive substrate of an LCD panel according to a fourth embodiment of the invention;

FIG. 6 is a partial top view of a first conductive substrate of an LCD panel according to a fifth embodiment of the invention;

FIG. 7 is a partial top view of a first conductive substrate of an LCD panel according to a sixth embodiment of the invention;

FIG. 8 is a partial top view of a first conductive substrate of an LCD panel according to a seventh embodiment of the invention;

FIG. 9A is a partial top view of a LCD panel according to an eighth embodiment of the invention; and

FIG. 9B is a partial cross-sectional view of the LCD panel viewed along the cross-sectional line 9B-9B′ of FIG. 9A.

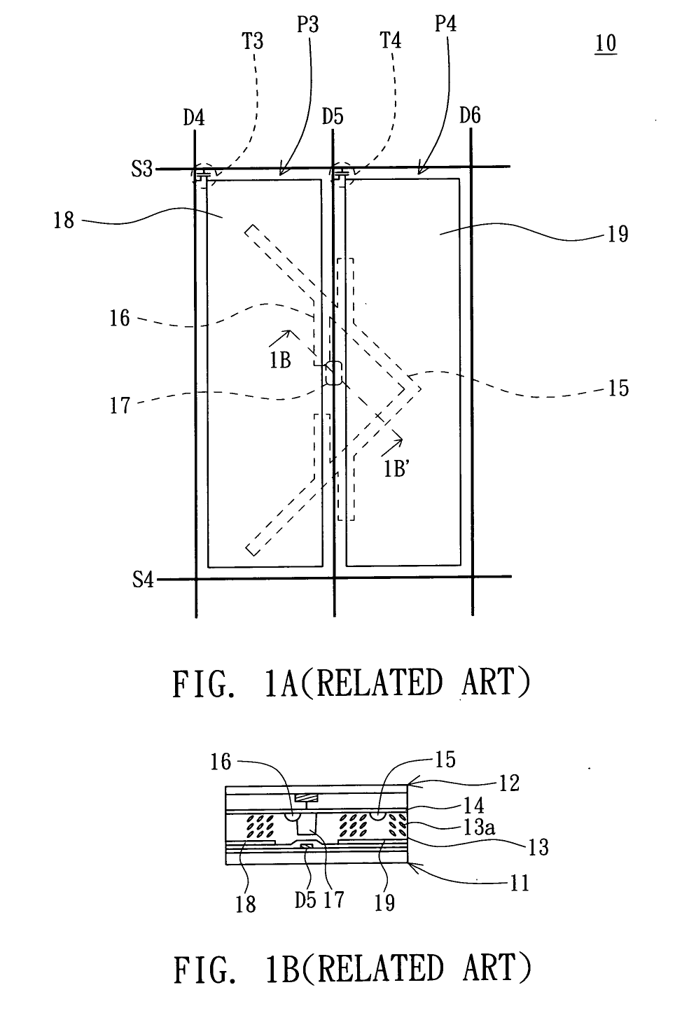

### DETAILED DESCRIPTION OF THE INVENTION

### First Embodiment

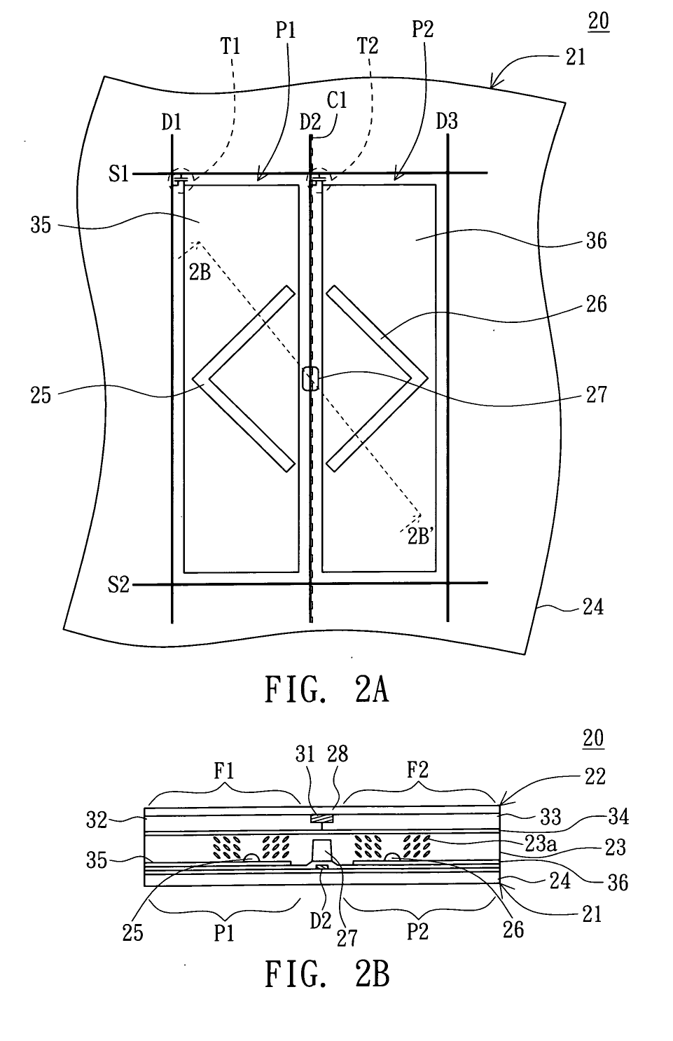

Referring to FIGS. 2A˜2B. FIG. 2A is a partial top view of a first conductive substrate of an LCD panel according to a first embodiment of the invention. FIG. 2B is a partial cross-sectional view of the LCD panel viewed along the cross-sectional line 2B-2B′ of FIG. 2A. As shown in FIGS. 2A˜2B, the LCD panel 20 at least includes a first conductive substrate 21, a second conductive substrate 22 and a liquid crystal layer 23. The first conductive substrate 21 at least includes a first base 24, a first protrusion 25, a second protrusion 26 and a photo-spacer 27. The first protrusion 25 and the second protrusion 26 disposed above the first base 24 are symmetric with respect to a first central line C1. The second protrusion 26 is a mirror reflection structure of the first protrusion 25 with respect to the first central line C1. In other words, the first protrusion 25 is also a mirror reflection structure of the second protrusion 26 with respect to the first central line C1. The photo-spacer 27 is substantially disposed on the first central line C1, positioned above the first base 24, and positioned between the first protrusion 25 and the second protrusion 26. The second conductive substrate 22 is parallel to the first conductive substrate 21. The liquid crystal layer 23 disposed between the first conductive substrate 21 and the second conductive substrate 22 has a number of liquid crystal molecules 23a. Besides, the first protrusion 25 and the second protrusion 26 are used for adjusting the liquid crystal molecules 23a of the liquid crystal layer 23 into a number of domains.

According to the design of the present embodiment of the invention, the first protrusion 25 and the second protrusion 26 are mutually mirrored and reflected with respect to the first central line C1, and the photo-spacer 27 is disposed on the first central line C1, not only preventing the photo-spacer 27 from partly overlapping the first protrusion 25 and the second protrusion 26 but also avoiding the occurrence of image retention during the operation of the LCD panel 20. Thus, the display quality and practicality of the LCD panel 20 are largely improved.

The first conductive substrate 21 and the second conductive substrate 22 can respectively be a thin film transistor (TFT) substrate and a color filter (CF) substrate, or a color filter substrate and a thin film transistor substrate, respectively. Besides, one of the first conductive substrate 21 and the second conductive substrate 22 can be a color filter on array (COA) thin film transistor substrate. In the present embodiment of the invention, the first conductive substrate 21 and the second conductive substrate 22 are exemplified by a thin film transistor substrate and a color filter substrate, respectively. However, the technology of the present embodiment of the invention is not limited thereto.

As for the detailed structure of the first conductive substrate 21 is exemplified below. However, the technology of the present embodiment of the invention is not limited thereto. For example, the first conductive substrate 21 further includes a first scan line S1, a second scan line S2, a first data line D1, a second data line D2 and a third data line D3. The first scan line S1 and the second scan line S2 are disposed above the first base 2 in parallel 4. The first data line D1, the second data line D2 and the third data line D3 are disposed above the first base 24 in parallel, perpendicular to and alternating with the first scan line S1 and the second scan line S2 to define an active matrix pixel array having a first pixel P1 and a second pixel P2. The first protrusion 25 and the second protrusion 26 are disposed in the first pixel P1 and the second pixel P2, respectively. The first central line C1 corresponds to the second data line D2. That is, the first central line C1 almost coincides with the second data line D2. To provide a detailed elaboration, the first central line C1 and the second data line D2 are slightly separated apart in FIG. 2A. The photo-spacer 27 is disposed on the second data line D2 and positioned between the first protrusion 25 and the second protrusion 26, hence preventing the first protrusion 25 from partly overlapping the second protrusion 26.

Besides, the first pixel P1 further includes a first thin film transistor T1 and a first pixel electrode 35. The second pixel P2 further includes a second thin film transistor T2 and a second pixel electrode 36. The first thin film transistor T1 is used to be electrically coupled to the first scan line S1 and the first data line D1. The first pixel electrode 35 is used to be electrically coupled to the first thin film transistor T1. The first protrusion 25 is disposed on the first pixel electrode 35. The second thin film transistor T2 is used to be electrically coupled to the first scan line S1 and the second data line D2. The second pixel electrode 36 is used to be electrically coupled to the second thin film transistor T2. The second protrusion 26 is disposed on the second pixel electrode 36.

As for the detailed structure of the second conductive substrate 22 is exemplified below. However, the technology of the present embodiment of the invention is not limited thereto. For example, the second conductive substrate 22 parallel to the first conductive substrate 21 includes a second base 28, a black matrix 31, a first color filter pixel F1, a second color filter pixel F2 and a common electrode 34. The black matrix 31 is disposed above the second base 28 and corresponds to the first scan line S1, the second scan line S2, the first data line D1, the second data line D2, the third data line D3, the first thin film transistor T1 and the second thin film transistor T2 of the first conductive substrate 21. Since the cross-sectional line 2B-2B′ only passes through the second data line D2 in FIG. 2A, FIG. 2B only illustrates the state of the black matrix 23 with respect to the second data line D2. The first color filter pixel F1 and the second color filter pixel F2 are disposed above the second base 28 side by side and respectively correspond to the first pixel P1 and the second pixel P2 of the first conductive substrate 21. That is, the first color filter pixel F1 and the second color filter pixel F2 respectively include a first color filter 32 and a second color filter 33. The first color filter 32 and the second color filter 33 are disposed above the second base 28. The boundary between the first color filter 32 and the second color filter 33 covers the black matrix 28. The first color filter 32 and the second color filter 33, which can be red (R) color filters, green (G) color filters or blue (B) color filters, can be color filters of the same or different colors. The common electrode 34 is disposed above the second base 28 and covers the first color filter 32 and the second color filter 33. It is noted that the first color filter pixel F1 and the second color filter pixel F2 can be two pixels of a color filter pixel array disposed above the second base 28.

In terms of the arrangement of the liquid crystal molecules 23a with respect to an electrical field, when the common electrode 34 and the first pixel electrode 35 receive or do not receive a voltage, the first protrusion 25 is used for adjusting the liquid crystal molecules 23a of the liquid crystal layer 23 into a number of domains. When the common electrode 34 and the second pixel electrode 36 receive or do not receive a voltage, the second protrusion 26 is used for adjusting the liquid crystal molecules 23a of the liquid crystal layer 23 into a number of domains.

The configuration of the first protrusion 25 and the second protrusion 26 is exemplified below. However, the technology of the present embodiment of the invention is not limited thereto. For example, the first protrusion 25 and the second protrusion 26 are two V-shaped protrusions with their two openings facing each other. The opening of the V-shaped protrusion faces the first central line C1. The V-shaped protrusion has two bar-shaped sub-protrusions, which are connected and perpendicular to each other. The two bar-shaped sub-protrusions tilt an angle such as 45 degrees or any angle with respect to the first scan line S1. Besides, the first protrusion 25 and the second protrusion 26 can be two V-shaped protrusions with their two openings positioned back-to-back. The opening of the V-shaped protrusion is back-to-back with respect to the first central line C1.

Any one who is skilled in the technology will understand that the technology of the present embodiment of the invention is not limited thereto. For example, the first base 24 and the second base 28 include a glass substrate, a plastic substrate, an insulated substrate, a ceramic substrate and a flexible substrate. Besides, the common electrode 34 includes a transparent conductive material. The first pixel electrode 35 and the second pixel electrode 36 include a transparent conductive material or a reflective conductive material. Furthermore, the first conductive substrate 21 further includes a first vertical alignment film. The first vertical alignment film is disposed on the first pixel electrode 35 and the second pixel electrode 36, and covers the first protrusion 25 and the second protrusion 26. Moreover, the second conductive substrate 22 further includes a second vertical alignment film. The second vertical alignment film covers the common electrode 34. The first vertical alignment film and the second vertical alignment film are used for assisting the vertical alignment of the liquid crystal molecules 23a. The first conductive substrate 21 further includes an electrode line. The electrode line disposed above the first base 24 is parallel to the first scan line S1. The electrode line passes through the first pixel P1 and the second pixel P2 disposed between the first scan line S1 and the second scan line S2, and is perpendicular to and alternating with the second data line D2 under the photo-spacer 27. That is, the photo-spacer 27 is disposed on the perpendicular alternating region between the electrode line and the second data line D2. The electrode line further passes under the connection between the two bar-shaped sub-protrusions of the first protrusion 25 and under the connection between the two bar-shaped sub-protrusions of the second protrusion 26.

### Second Embodiment

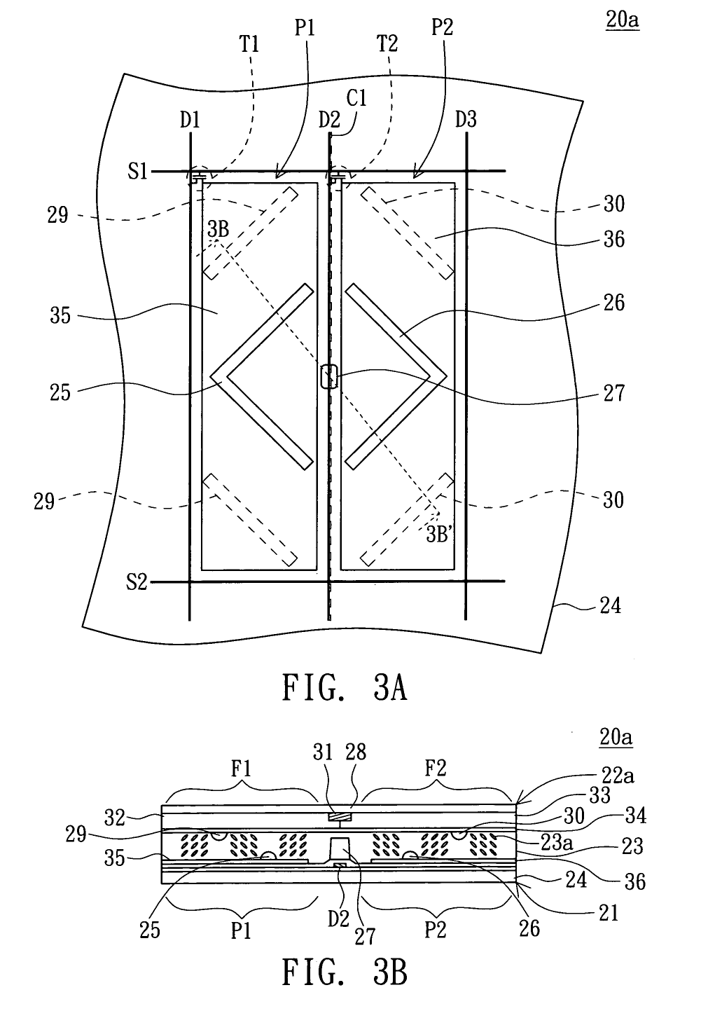

Referring to FIGS. 3A˜3B. FIG. 3A is a partial top view of an LCD panel according to a second embodiment of the invention. FIG. 3B is a partial cross-sectional view of the LCD panel viewed along a cross-sectional line 3B-3B′ of FIG. 3A. The LCD panel 20a of the present embodiment of the invention differs from the LCD panel 20 of the first embodiment in a second conductive substrate 22a, while the second conductive substrate 22a of the present embodiment of the invention differs from the second conductive substrate 22 of the first embodiment in an third protrusion 29 and a fourth protrusion 30. As for other similar elements, the same reference numbers are used and are not repeated here.

As shown in FIGS. 3A˜3B, the third protrusion 29 and the fourth protrusion 30 respectively disposed in the first color filter pixel F1 and the second color filter pixel F2 are disposed above the second base 28. To elaborate in more details, the third protrusion 29 and the fourth protrusion 30 disposed on the common electrode 34 correspond to the first protrusion 25 and the second protrusion 26, respectively. The present embodiment of the invention is exemplified by two third protrusions 29 and two fourth protrusions 30. Therefore, the two third protrusions 29 correspond to the two bar-shaped sub-protrusions of the first protrusion 25, and the two fourth protrusions 30 correspond to the two bar-shaped sub-protrusions of the second protrusion 26. That is, the two third protrusions 29 are parallel to the two bar-shaped sub-protrusions of the first protrusion 25, while the two fourth protrusions 30 are parallel to the two bar-shaped sub-protrusions of the second protrusion 26. Therefore, the first protrusion 25 and the third protrusion 29 are used for adjusting the liquid crystal molecules 23a positioned between the first pixel P1 and the first color filter pixel F1 into a number of domains, while the second protrusion 26 and the fourth protrusion 30 are used for adjusting the liquid crystal molecules 23a positioned between second pixel P1 and the second color filter pixel F2 into a number of domains.

Any one who is skilled in the technology will understand that the technology of the present embodiment of the invention is not limited thereto. For example, the two third protrusions 29 can be extended to the other pixel to form a V-shaped protrusion whose opening faces the first central line C1 with the extended connection of the two third protrusions 29 corresponding to the left pixel of the first pixel P1 of FIG. 2A. The two fourth protrusions 30 can be extended to the other pixel to form a V-shaped protrusion whose opening faces the first central line C1 with the extension of the two third protrusions 29 corresponding to the right pixel of the first pixel P1 of FIG. 2A. Besides, the second conductive substrate 22a further includes a third vertical alignment film. The third vertical alignment film disposed on the common electrode 34 covers the third protrusion 29 and the fourth protrusion 30. The third protrusion 29 and the fourth protrusion 30 are two mutually mirrored and reflected structures with respect to the first central line C1.

### Third Embodiment

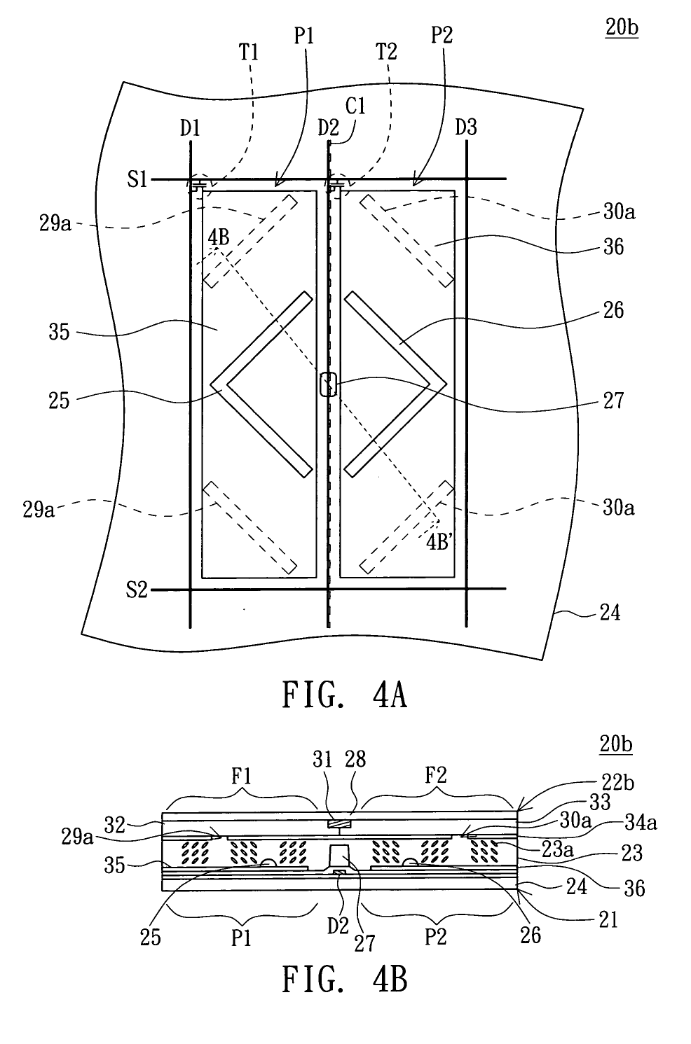

Referring to FIGS. 4A˜4B. FIG. 4A is a partial top view of an LCD panel according to a third embodiment of the invention. FIG. 4B is a partial cross-sectional view of the LCD panel viewed along a cross-sectional line 4B-4B′ of FIG. 4A. The LCD panel 20b of the present embodiment of the invention differs from the LCD panel 20 of the first embodiment in a second conductive substrate 22b, while the second conductive substrate 22b of the present embodiment of the invention differs from the second conductive substrate 22 of the first embodiment in a common electrode 34a, a first slit 29a and a second slit 30a. As for other similar elements, the same reference numbers are used and are not repeated here.

As shown in FIGS. 4A˜4B, the common electrode 34a has a first slit 29a and a second slit 30a, such as two first slits 29a and two second slits 30a, for instance. The first slit 29a and the second slit 30a are respectively positioned in the first color filter pixel F1 and the second color filter pixel F2, and correspond to the first protrusion 25 and the second protrusion 26, respectively. That is, the two first slits 29a are parallel to the two bar-shaped sub-protrusions of the first protrusion 25, while the two second slits 30a are parallel to the two bar-shaped sub-protrusions of the second protrusion 26 in FIG. 4A. The respective positions of the first slit 29a and the second slit 30a on the first color filter pixel F1 and the second color filter pixel F2 are substantially the same with the respective positions of the third protrusion 29 and the fourth protrusion 30 of the first embodiment on the first color filter pixel F1 and the second color filter pixel F2, respectively. Therefore, the first protrusion 25 and the first slit 29a are used for adjusting the liquid crystal molecules 23a between the first pixel P1 and the first color filter pixel F1 into a number of domains, while the second protrusion 26 and the second slit 30a are used for adjusting the liquid crystal molecules 23a between the second pixel P1 and the second color filter pixel F2 into a number of domains.

Any one who is skilled in the technology will understand that the technology of the present embodiment of the invention is not limited thereto. For example, the two first slits 29a can be extended to the other pixel to form a V-shaped slit whose opening faces the first central line C1 with the extended connection of the two first slits 29a corresponding to the left pixel of the first pixel P1 of FIG. 3A. The two second slit 30a can be extended to the other pixel to form a V-shaped slit whose opening faces the first central line C1 with the extended connection of the two second slits 30a corresponding to the right pixel of the second pixel P2 of FIG. 3A. Besides, the second conductive substrate 22b further includes a fourth vertical alignment film. The fourth vertical alignment film disposed on the common electrode 34 can cover the first slit 29a and the second slit 30a, but is unable to fill up the first slit 29a and the second slit 30a. The first slit 29a and the second slit 30a are two mutually mirrored and reflected structures with respect to the first central line C1.

### Fourth Embodiment

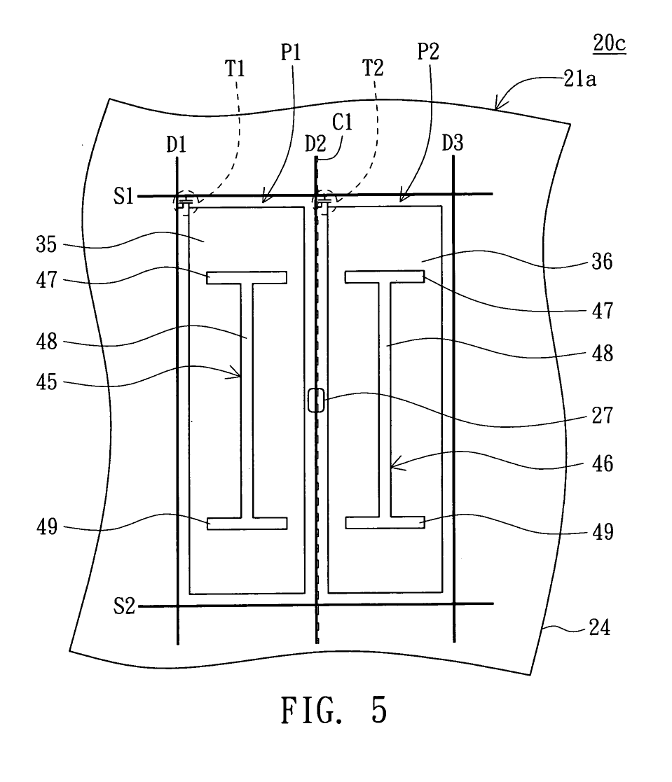

Referring to FIG. 5, a partial top view of a first conductive substrate of an LCD panel according to a fourth embodiment of the invention is shown. The LCD panel 20c of the present embodiment of the invention differs from the LCD panel 20 of the first embodiment in a first conductive substrate 21a, while the first conductive substrate 21a of the present embodiment of the invention differs from the first conductive substrate 21 of the first embodiment in the shape and arrangement of a first protrusion 45 and a second protrusion 46. As for other similar elements, the same reference numbers are used and are not repeated here.

As shown in FIG. 5, the first protrusion 45 and the second protrusion 46 disposed above the first base 24 are symmetric with respect to the first central line C1. The second protrusion 46 is a mirror reflection structure of the first protrusion 45 with respect to the first central line C1. In other words, the first protrusion 45 is also a mirror reflection structure of the second protrusion 46 with respect to the first central line C1. The photo-spacer 27 substantially disposed on the first central line C1 and positioned above the first base 24 is positioned between the first protrusion 45 and the second protrusion 46. In the present embodiment of the invention, the first protrusion 45 and the second protrusion 46 are two I-shaped protrusions. Each of the I-shaped first protrusion 45 and the second protrusion 46 has a top portion 47, a connecting portion 48 and a bottom portion 49. The connecting portion 48 connects the top portion 47 and the bottom portion 49. The top portion 47 is parallel to the bottom portion 49. An angle such as 0 degree is contained between the connecting portion 48 and the first central line C1. That is, the connecting portion 48 is parallel to the first central line C1 and the second data line D2, while the top portion 47 and the bottom portion 49 are parallel to the first scan line S1.

Any one who is skilled in the technology will understand that the technology of the present embodiment of the invention is not limited thereto. For example, according to the design of the third protrusion 29, the fourth protrusion 30, the first slit 29a and the fourth slit 30a disclosed in the second embodiment and the third embodiment, the present embodiment of the invention can further dispose the third protrusion and the fourth protrusion or the first slit and the second slit on the second conductive substrate parallel to the first conductive substrate 21a. The third protrusion and the fourth protrusion or the first slit and the second slit are parallel to the first protrusion 45 and the second protrusion 46.

### Fifth Embodiment

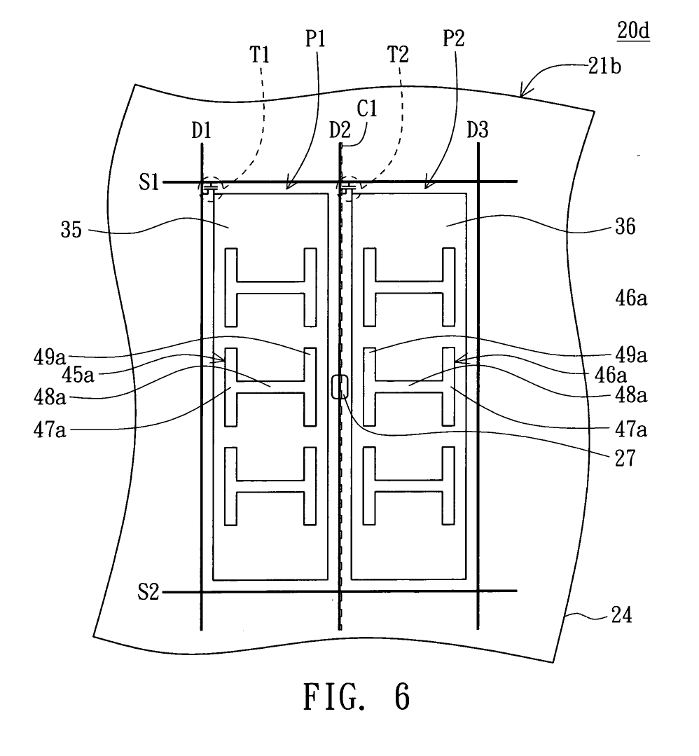

Referring to FIG. 6, a partial top view of a first conductive substrate of an LCD panel according to a fifth embodiment of the invention is shown. The LCD panel 20d of the present embodiment of the invention differs from the LCD panel 20 of the first embodiment in a first conductive substrate 21b, while the first conductive substrate 21b of the present embodiment of the invention differs from the first conductive substrate 21 of the first embodiment in the shape and arrangement of a first protrusion 45a and a second protrusion 46a. As for other similar elements, the same reference numbers are used and are not repeated here.

As shown in FIG. 6, the first protrusion 45a and the second protrusion 46a disposed above the first base 24 are symmetric with respect to the first central line C1. The second protrusion 46a is a mirror reflection structure of the first protrusion 45a with respect to the first central line C1. In other words, the first protrusion 45a is also a mirror reflection structure of the second protrusion 46a with respect to the first central line C1. The photo-spacer 27 substantially disposed on the first central line C1 and positioned above the first base 24 is positioned between the first protrusion 45a and the second protrusion 46a, wherein the space between the first protrusion 45a and the second protrusion 46a is large enough to receive the photo-spacer 27. In the present embodiment of the invention, the first protrusion 45a and the second protrusion 46a are two I-shaped protrusions. The I-shaped first protrusion 45a and second protrusion 46a each has a top portion 47a, a connecting portion 48a and a bottom portion 49a. The connecting portion 48a connects the top portion 47a and the bottom portion 49a. The top portion 47a is parallel to the bottom portion 49a. An angle such as 90 degrees is contained between the connecting portion 48a and the first central line C1 forms. That is, the connecting portion 48a is perpendicular to the first central line C1 and the second data line D2. The top portion 47 and the bottom portion 49 are perpendicular to the first scan line S1. The top portion 47a is farther from the first central line C1 while the bottom portion 49a is closer to the first central line C1.

### Sixth Embodiment

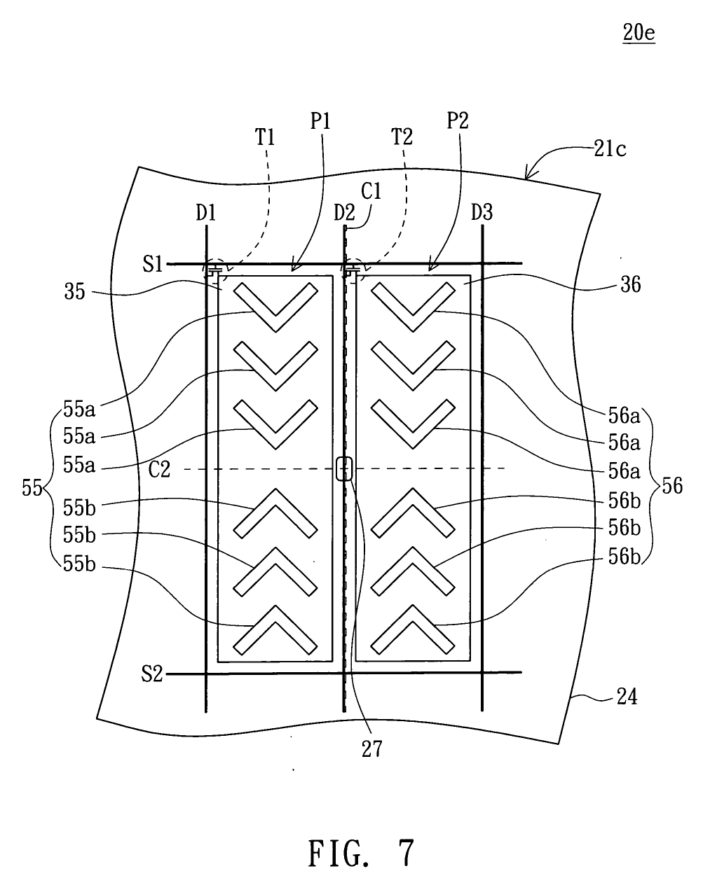

Referring to FIG. 7, a partial top view of a first conductive substrate of an LCD panel according to a sixth embodiment of the invention is shown. The LCD panel 20e of the present embodiment of the invention differs from the LCD panel 20 of the first embodiment in a first conductive substrate 21c, while the first conductive substrate 21c of the present embodiment of the invention differs from the first conductive substrate 21 of the first embodiment in the shape and arrangement of a first protrusion 55 and a second protrusion 55. As for other similar elements, the same reference numbers are used and are not repeated here.

As shown in FIG. 7, the first protrusion 55 and the second protrusion 56 disposed above the first base 24 are symmetric with respect to the first central line C1. The second protrusion 56 is a mirror reflection structure of the first protrusion 55 with respect to the first central line C1. In other words, the first protrusion 55 is also a mirror reflection structure of the second protrusion 56 with respect to the first central line C1. The photo-spacer 27 substantially disposed on the first central line C1 and positioned above the first base 24 is positioned between the first protrusion 55 and the second protrusion 56. Besides, the first protrusion 55 includes at least a V-shaped sub-protrusion 55a and at least an inverted V-shaped sub-protrusion 55b. The V-shaped sub-protrusion 55a and the inverted V-shaped sub-protrusion 55b are symmetric with respect to a second central line C2. The inverted V-shaped sub-protrusion 55a is a mirror reflection structure of the V-shaped sub-protrusion 55b with respect to the second central line C2. The V-shaped sub-protrusion 55a is a mirror reflection structure of the inverted V-shaped sub-protrusion 55b with respect to the second central line C2. An angle such as 90 degrees is contained between the second central line C2 and the first central line C1. That is, the second central line C2 is perpendicular to the first central line C1. Furthermore, the second protrusion 56 includes at least one V-shaped sub-protrusion 56a and at least one inverted V-shaped sub-protrusion 56b. The V-shaped sub-protrusion 56a and the inverted V-shaped sub-protrusion 56b are symmetric with respect to the second central line C2. The inverted V-shaped sub-protrusion 56b is a mirror reflection structure of the V-shaped sub-protrusion 56a with respect to the second central line C2. The V-shaped sub-protrusion 56a is a mirror reflection structure of the inverted V-shaped sub-protrusion 56b with respect to the second central line C2. In the present embodiment of the invention, the first protrusion 55 includes three V-shaped sub-protrusions 55a and three inverted V-shaped sub-protrusions 55b. The second protrusion 56 includes three V-shaped sub-protrusions 56a and three inverted V-shaped sub-protrusions 56b. However, the number of the V-shaped sub-protrusions 56a and the inverted V-shaped sub-protrusions 56b of the present embodiment of the invention is not limited thereto.

### Seventh Embodiment

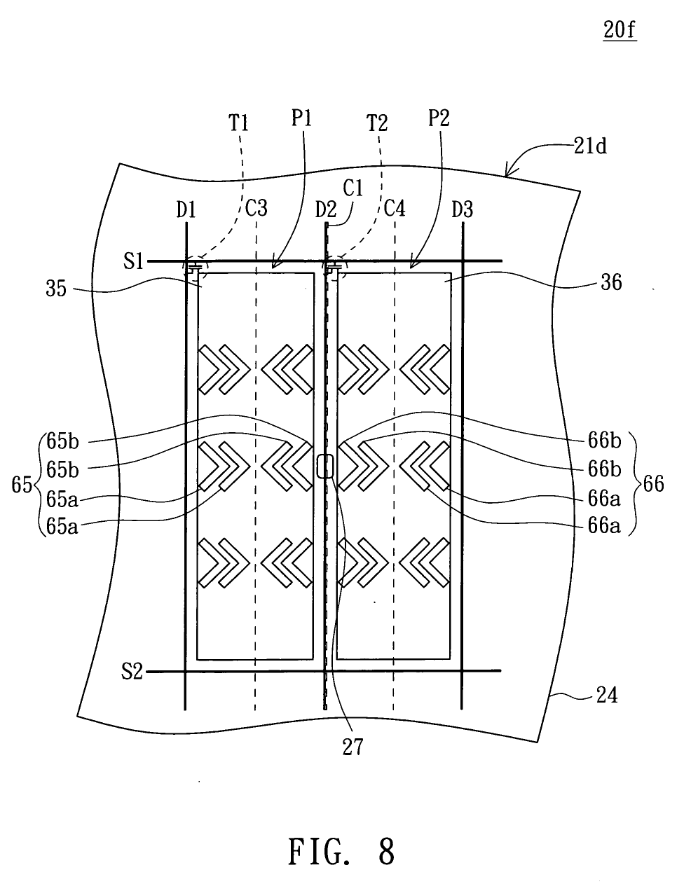

Referring to FIG. 8, a partial top view of a first conductive substrate of an LCD panel according to a seventh embodiment of the invention is shown. The LCD panel 20f of the present embodiment of the invention differs from the LCD panel 20 of the first embodiment in a first conductive substrate 21d, while the first conductive substrate 21d of the present embodiment of the invention differs from the first conductive substrate 21 of the first embodiment in the shape and arrangement of a first protrusion 65 and a second protrusion 66. As for other similar elements, the same reference numbers are used and are not repeated here.

As shown in FIG. 8, the first protrusion 65 and the second protrusion 66 disposed above the first base 24 are symmetric with respect to the first central line C1. The second protrusion 66 is a mirror reflection structure of the first protrusion 65 with respect to the first central line C1. In other words, the first protrusion 65 is also a mirror reflection structure of the second protrusion 66 with respect to the first central line C1. The photo-spacer 27 substantially disposed on the first central line C1 and positioned above the first base 24 is positioned between the first protrusion 65 and the second protrusion 66. Besides, the first protrusion 65 includes at least one V-shaped sub-protrusion 65a and at least one inverted V-shaped sub-protrusion 65b. The V-shaped sub-protrusion 65a and the inverted V-shaped sub-protrusion 65b are symmetric with respect to a third central line C3. The inverted V-shaped sub-protrusion 65a is a mirror reflection structure of V-shaped sub-protrusion 65b with respect to the third central line C3. The V-shaped sub-protrusion 65a is a mirror reflection structure of the inverted V-shaped sub-protrusion 65b with respect to the third central line C3. An angle such as 0 degree is contained between the third central line C3 and the first central line C1. That is, the third central line C3 is parallel to the first central line C1. The V-shaped sub-protrusion 65a is farther from the first central line C1, while the inverted V-shaped sub-protrusion 65b is closer to the first central line C1.

Furthermore, the second protrusion 66 includes at least a V-shaped sub-protrusion 66a and at least an inverted V-shaped sub-protrusion 66b. The V-shaped sub-protrusion 66a and the inverted V-shaped sub-protrusion 66b are symmetric with respect to a fourth central line C4. The inverted V-shaped sub-protrusion 66b is a mirror reflection structure of the V-shaped sub-protrusion 66a with respect to the fourth central line C4. The V-shaped sub-protrusion 66a is a mirror reflection structure of the inverted V-shaped sub-protrusion 66b with respect to the fourth central line C4. An angle such as 0 degree is contained between the fourth central line C4 and the first central line C1. That is, the fourth central line C4 is parallel to the first central line C1. The V-shaped sub-protrusion 66a is farther from the first central line C1, while the inverted V-shaped sub-protrusion 66b is closer to the first central line C1.

In the present embodiment of the invention, the first protrusion 65 includes two V-shaped sub-protrusions 65a and two inverted V-shaped sub-protrusions 65b. The second protrusion 66 includes two V-shaped sub-protrusions 66a and two inverted V-shaped sub-protrusions 66b. However, the number of the V-shaped sub-protrusions 66a and inverted V-shaped sub-protrusions 66b of the present embodiment of the invention is not limited thereto.

### Eighth Embodiment

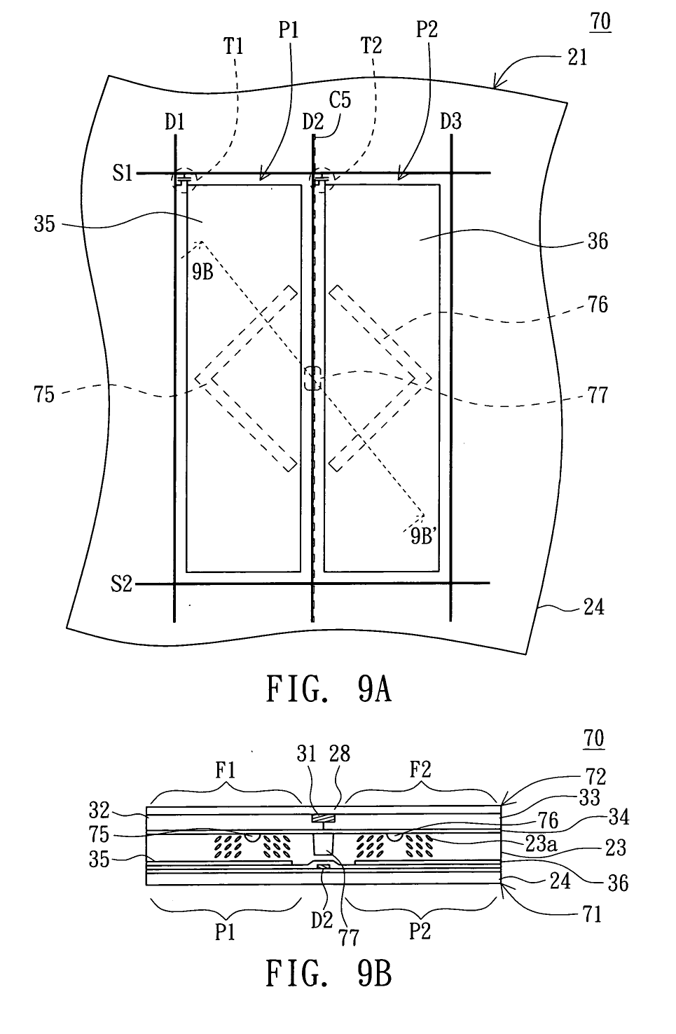

Referring to FIGS. 9A˜9B. FIG. 9A is a partial top view of an LCD panel according to an eighth embodiment of the invention. FIG. 9B is a partial cross-sectional view of the LCD panel viewed along the cross-sectional line 9B-9B′ of FIG. 9A. The LCD panel 70 of the present embodiment of the invention differs from the LCD panel 20 of the first embodiment in a first conductive substrate 71 and a second conductive substrate 72. The second conductive substrate 72 of the present embodiment of the invention differs from the second conductive substrate 22 of the first embodiment in a first protrusion 75 and a second protrusion 76. The first conductive substrate 71 of the present embodiment of the invention differs from the first conductive substrate 21 of the first embodiment in omitting the first protrusion 25 and the second protrusion 26 of the first conductive substrate 21. As for other similar elements, the same reference numbers are used and are not repeated here.

As shown in FIGS. 9A·9B, the first protrusion 75 and the second protrusion 76 are respectively disposed in the first color filter pixel F1 and the second color filter pixel F2. The first protrusion 75 and the second protrusion 76 disposed above the second base 28 are symmetric with respect to a first central line C5. Furthermore, the first protrusion 75 and the second protrusion 76 disposed on the common electrode 34 are symmetric with respect to the first central line C5. The second protrusion 76 is a mirror reflection structure of the first protrusion 75 with respect to the first central line C5. The first protrusion 75 is also a mirror reflection structure of the second protrusion 76 with respect to the first central line C5. The photo-spacer 77 substantially disposed on the first central line C5 and positioned above the second base 28 is positioned between the first protrusion 75 and the second protrusion 76. The first central line C5 corresponds to the boundary between the first color filter pixel F1 and the second color filter pixel F2. The photo-spacer 77 is disposed on the boundary between the first color filter pixel F1 and the second color filter pixel F2. Besides, the first protrusion 75 and the second protrusion 76 correspond to the first pixel P1 and the second pixel P2, respectively. The first central line C5 corresponds to the second data line D2. The photo-spacer 77 corresponds to the second data line D2.

In the present embodiment of the invention, the first protrusion 75 and the second protrusion 76 are two V-shaped protrusions whose openings are positioned back-to-back. The opening of the V-shaped protrusion faces towards the first central line C5. Each of the V-shaped first protrusion 75 and second protrusion 76 has two bar-shaped sub-protrusions, which are connected together and perpendicular to each other. The two bar-shaped sub-protrusions tilt an angle such as 45 degrees with respect to the first scan line S1. Besides, the first protrusion 75 and the second protrusion 76 can be two V-shaped protrusions whose openings positioned back-to-back. The opening of V-shaped protrusion is also back-to-back with respect to the first central line C5.

Any one who is skilled in the technology will understand that the technology of the present embodiment of the invention is not limited thereto. For example, according to the design of the third protrusion 29, the fourth protrusion 30, the first slit 29a and the fourth slit 30a disclosed in the second embodiment and the third embodiment, the present embodiment of the invention can further dispose the third protrusion and the fourth protrusion or the first slit and the second slit on the first conductive substrate 71 parallel to the second conductive substrate 72. The third protrusion and the fourth protrusion or the first slit and the second slit correspond to the first protrusion 75 and the second protrusion 76, respectively. In the present embodiment of the invention, the third protrusion and the fourth protrusion can be disposed in the first pixel P1 and the second pixel P2, respectively. For example, the third protrusion and the fourth protrusion are disposed in the first pixel electrode 35 and the second pixel electrode 36, respectively. The first slit and the second slit can be disposed in the first pixel P1 and the second pixel P2, respectively. For example, the first pixel electrode 35 and the second pixel electrode 36 respectively have the first slit and the second slit.

According to the technology of the fifth embodiment and the sixth embodiment, the present embodiment of the invention can design the first protrusion 75 and the second protrusion 77 as two I-shaped protrusions. The connecting portion of the I-shaped protrusion tilts an angle such as 0 degree, 30 degrees, 45 degrees, 60 degrees, 90 degree or any angle with respect to the first central line C5. Besides, a number of I-shaped protrusions can be disposed in the first color filter pixel F1 of the present embodiment of the invention, while a number of I-shaped protrusions can be disposed in the second color filter pixel F2. Furthermore, incorporated with the position and alignment of the I-shaped protrusion, the third protrusion and the fourth protrusion or the first slit and the second slit can be correspondingly disposed on the first conductive substrate 71.

Likewise, according to the technology of the seventh embodiment and the eighth embodiment, the present embodiment of the invention can design the first protrusion 75 and the second protrusion 77 to include at least a V-shaped sub-protrusion and at least an inverted V-shaped sub-protrusion, respectively. The V-shaped sub-protrusion and the inverted V-shaped sub-protrusion are symmetric with respect to a sixth central line. The mirror reflection structure of the inverted V-shaped sub-protrusion is a V-shaped sub-protrusion with respect to the sixth central line. The V-shaped sub-protrusion is a mirror reflection structure of the inverted V-shaped sub-protrusion with respect to the sixth central line. The sixth central line tilts an angle such as 0 degrees, 30 degrees, 45 degrees, 60 degrees, 90 degree or any angle with respect to the first central line C5. Besides, a number of V-shaped sub-protrusions and a number of inverted V-shaped sub-protrusions can be disposed in the first color filter pixel F1 of the present embodiment of the invention, while a number of V-shaped sub-protrusions and a number of inverted V-shaped sub-protrusions can be disposed in the second color filter pixel F2. Moreover, incorporated with the position and alignment of the V-shaped sub-protrusion and the inverted V-shaped sub-protrusion, the third protrusion and the fourth protrusion or the first slit and the second slit can be correspondingly disposed on the first conductive substrate 71.

According to the present embodiment of the invention, the photo-spacer is disposed on a symmetric central line positioned between two protrusions, while the two mutually mirrored and reflected protrusions are symmetric with respect to a central line. The shape and arrangement of the first protrusion and the second protrusion are not limited to the shape and arrangement disclosed in the above embodiments. Any design of the shape and arrangement of the protrusion capable of preventing partial overlapping between the photo-spacer and the protrusion is applicable to two mutually mirrored and reflected protrusions of the present embodiment of the invention. For example, the two mutually mirrored and reflected protrusions can respectively be one or several cross-shaped protrusions, one or several Y-shaped protrusions, one or several X-shaped protrusions, one or several T-shaped protrusions, one or several bar-shaped sub-protrusions parallel to the scan line, one or several bar-shaped sub-protrusions parallel to the data line, one or several diagonal bar-shaped sub-protrusions of the pixel tilting 45 degrees with respect to the scan line. Besides, the mutually mirrored and reflected protrusions can respectively be a combination of one or several Y-shaped sub-protrusions and inverted Y-shaped sub-protrusions or a combination of one or several T-shaped sub-protrusions and inverted T-shaped sub-protrusions.

Despite the pixels P1 and P2 of the present embodiment of the invention are respectively exemplified by a vertical rectangular region, that is, the edge of the scan line of the pixels P1 and P2 is shorter than the edge of the data line of the pixels P1 and P2. However, the technology of the present embodiment of the invention is not limited thereto. For example, the pixels P1 and P2 can be respectively exemplified by a horizontal rectangular region, that is, the edge of the scan line of the pixels P1 and P2 is longer than the edge of the data line of the pixels P1 and P2. Or, the pixels P1 and P2 can respectively be a squared region, that is, the edge of the scan line of the pixels P1 and P2 is equal to the edge of the data line of the pixels P1 and P2.

In the present embodiment of the invention, the first protrusion and the second protrusion, which are mutually mirrored and reflected, are respectively positioned in pixel P1 and pixel P2. However, the mutually mirrored and reflected first protrusion and second protrusion can be disposed crossing over two or more pixels. Likewise, the mutually mirrored and reflected first protrusion and second protrusion can be repeatedly and regularly disposed in the active matrix pixel array of the LCD panel at an interval of a fixed number of pixels. Or, the mutually mirrored and reflected first protrusion and second protrusion can repeatedly and regularly correspond to the color filter pixel array of LCD panel at an interval of a fixed number of pixels.

Besides, when one of the first conductive substrate and the second conductive substrate is a thin film transistor substrate of a color filter on an array, then each pixel of active matrix pixel array has a corresponding color filter. That is, in the thin film transistor substrate of the color filter on the array, each pixel of the active matrix pixel array corresponds to a pixel of the color filter pixel array.

According to the LCD panel disclosed in the above embodiments of the invention, the design of disposing two mutually mirrored and reflected protrusions to be symmetric with respect to a central line and disposing the photo-spacer on a symmetric central line positioned between the two protrusions prevents the photo-spacer from partly overlapping with the two protrusions, and avoids the occurrence of image retention during the operation of the LCD panel. Thus, the display quality and practicality of the LCD panel are largely improved.

Any one who is skilled in the technology will understand that the technology of the present embodiment of the invention is not limited thereto. For example, the two bar-shaped sub-protrusions of the V-shaped sub-protrusion 65a, which are connected and perpendicular to each other, tilt an angle such as 45 degrees with respect to the third central line C3. Likewise, the two bar-shaped sub-protrusions of the V-shaped sub-protrusion 66a, which are connected and perpendicular to each other, tilt 45 degrees with respect to the fourth central line C4. The two bar-shaped sub-protrusions of the inverted V-shaped sub-protrusion 65b, which are connected and perpendicular to each other, tilt 45 degrees with respect to the third central line C3. The two bar-shaped sub-protrusions of the inverted V-shaped sub-protrusion 66b, which are connected together and perpendicular to each other, tilt 45 degrees with respect to the fourth central line C4. The openings of the V-shaped sub-protrusion 65a and the inverted V-shaped sub-protrusion 65b can be positioned face-to-face or back-to-back with respect to the third central line C3. The openings of the V-shaped sub-protrusion 66a and inverted V-shaped sub-protrusion 66b can be positioned face-to-face or back-to-back with respect to the fourth central line C4. According to the design of the third protrusion 29, the fourth protrusion 30, the first slit 29a and the fourth slit 30a of the second embodiment and the third embodiment, the present embodiment of the invention can further dispose the third protrusion and the fourth protrusion or the first slit and the second slit on the second conductive substrate parallel to the first conductive substrate 21d. The third protrusion and the fourth protrusion or the first slit and the second slit correspond to the first protrusion 65 and the second protrusion 66, respectively. Furthermore, the present embodiment of the invention can dispose three first protrusions 65 in the first pixel P1 or dispose three second protrusions 66 in the second pixel P2.

Any one who is skilled in the technology will understand that the technology of the present embodiment of the invention is not limited thereto. For example, the two V-shaped sub-protrusion 55a bar-shaped sub-protrusions, which are connected and perpendicular to each other, tilt an angle such as 45 degrees with respect to the second central line C2. Likewise, the two V-shaped sub-protrusion 56a bar-shaped sub-protrusions, which are connected together and perpendicular to each other, tilt 45 degrees with respect to the second central line C2. The two inverted V-shaped sub-protrusion 55b bar-shaped sub-protrusions, which are connected together and perpendicular to each other, tilt 45 degrees with respect to the second central line C2. The two inverted V-shaped sub-protrusion 56b bar-shaped sub-protrusions, which are connected together and perpendicular to each other, tilt 45 degrees with respect to the second central line C2. The openings of the V-shaped sub-protrusions 55a and 56a and the openings of the inverted V-shaped sub-protrusion 55b and 56b can be positioned face-to-face or back-to-back with respect to the second central line C2. According to the design of the third protrusion 29, the fourth protrusion 30, the first slit 29a and the fourth slit 30a of the second embodiment and the third embodiment, the present embodiment of the invention can further dispose the third protrusion and the fourth protrusion or the first slit and the second slit on the second conductive substrate parallel to the first conductive substrate 21c. The third protrusion and the fourth protrusion or the first slit and the second slit correspond to the first protrusion 55 and the second protrusion 56, respectively.

Any one who is skilled in the technology will understand that the technology of the present embodiment of the invention is not limited thereto. For example, according to the design of the third protrusion 29, the fourth protrusion 30, the first slit 29a and the fourth slit 30a disclosed in the second embodiment and the third embodiment, the present embodiment of the invention can further dispose the third protrusion and the fourth protrusion or the first slit and the second slit on the second conductive substrate parallel to the first conductive substrate 21b. The third protrusion and the fourth protrusion or the first slit and the second slit correspond to the first protrusion 45a and the second protrusion 46a, respectively. Besides, the connecting portion 48a can tilt 30 degrees, 45 degrees, 60 degrees, 90 degree or any angle with respect to the first central line C1. Furthermore, in the present embodiment of the invention can dispose three first protrusions 45a in the first pixel P1 and/or dispose three second protrusions 46a in the second pixel P2.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A liquid crystal display (LCD) panel, comprising:
a first substrate, comprising:
a first base;
a first protrusion and a second protrusion, which are disposed above the first base and symmetric with respect to a first central line, wherein the second protrusion is a mirror reflection structure of the first protrusion with respect to the first central line; and
a photo-spacer substantially disposed on the first central line, positioned above the first base, and positioned between the first protrusion and the second protrusion;
a second substrate parallel to the first conductive substrate; and
a liquid crystal layer interposed between the first substrate and the second substrate.

2. The LCD panel according to claim 1, wherein the first protrusion is a V-shaped protrusion having an opening facing the first central line.

3. The LCD panel according to claim 1, wherein:
the first protrusion is an I-shaped protrusion having a top portion, a connecting portion, and a bottom portion,
the connecting portion connects the top portion and the bottom portion, and
the top portion is substantially parallel to the bottom portion.

4. The LCD panel according to claim 3, wherein the connecting portion and the first central line form an angle ranging from about 0 degree to about 90 degrees.

5. The LCD panel according to claim 1, wherein:
the first protrusion comprises at least one V-shaped sub-protrusion and at least one inverted V-shaped sub-protrusion,
the V-shaped sub-protrusion and the inverted V-shaped sub-protrusion are symmetric with respect to a second central line, and
the inverted V-shaped sub-protrusion is a mirror reflection structure of the V-shaped sub-protrusion with respect to the second central line.

6. The LCD panel according to claim 5, wherein the second central line and the first central line form an angle ranging from about 0 degree to about 90 degrees.

7. The LCD panel according to claim 5, wherein the first protrusion comprises a plurality of V-shaped sub-protrusions and a plurality of inverted V-shaped sub-protrusions.

8. The LCD panel according to claim 1, wherein the first substrate further comprises:
a first scan line and a second scan line, which are disposed above the first base in parallel; and
a first data line, a second data line and a third data line, which are disposed above the first base in parallel, perpendicular to and alternating with the first scan line and the second scan line so as to define a first pixel and a second pixel;
wherein the first protrusion and the second protrusion are disposed in the first pixel and the second pixel, respectively, the first central line corresponds to the second data line, and the photo-spacer is disposed on the second data line.

9. The LCD panel according to claim 1, wherein the first substrate further comprises:
a first color filter element and a second color filter element, which are disposed above the first base side by side;
wherein the first protrusion and the second protrusion are disposed on the first color filter element and the second color filter element, respectively, the first central line corresponds to the boundary between the first color filter element and the second color filter element, and the photo-spacer is disposed on the boundary between the first color filter element and the second color filter element.

10. The LCD panel according to claim 1, wherein the second substrate comprises:
a second base;
a first scan line and a second scan line, which are disposed above the second base in parallel; and
a first data line, a second data line and a third data line, which are disposed above the second base in parallel, perpendicular to and alternating with the first scan line and the second scan line so as to define a first pixel and a second pixel;
wherein the first protrusion and the second protrusion are corresponding to the first pixel and the second pixel, respectively, the first central line corresponds to the second data line, and the photo-spacer corresponds to the second data line.

11. The LCD panel according to claim 1, wherein the second substrate comprises:
a second base; and
a third protrusion disposed above the second base with respect to the first protrusion.

12. The LCD panel according to claim 1, wherein the second substrate comprises:
a second base; and
a common electrode, disposed above the second base, having a slit corresponding to the first protrusion.

13. The LCD panel according to claim 1, wherein the second substrate comprises:
a second base;
a first scan line and a second scan line, which are disposed above the second base in parallel;
a first data line, a second data line and a third data line, which are disposed above the second base in parallel, perpendicular to and alternating with the first scan line and the second scan line so as to define a first pixel and a second pixel; and
a third protrusion and a fourth protrusion, which are disposed in the first pixel and the second pixel, respectively, and corresponding to the first protrusion and the second protrusion.

14. The LCD panel according to claim 1, wherein the second substrate comprises:
a second base;
a first scan line and a second scan line, which are disposed above the second base in parallel;
a first data line, a second data line and a third data line, which are disposed above the second base in parallel, perpendicular to and alternating with the first scan line and the second scan line so as to define a first pixel and a second pixel; and
a first pixel electrode and a second pixel electrode, which are disposed in the first pixel and the second pixel, respectively, and have a first slit and a second slit, wherein the first slit and the second slit are corresponding to the first protrusion and the second protrusion, respectively.

15. The LCD panel according to claim 1, wherein the first substrate and the second substrate are a thin film transistor (TFT) substrate and a color filter (CF) substrate, respectively.

16. The LCD panel according to claim 1, wherein the first substrate and the second substrate are a CF substrate and a TFT substrate, respectively.

17. The LCD panel according to claim 1, wherein at least one of the first substrate and the second substrate comprises a color filter on array (COA) TFT substrate.
